(19) United States
(12) Patent Application Publication
(10) Pub. No.: US 2026/0268108 A1
(43) Pub. Date: Sep. 10, 2026

(54) INFORMATION PROCESSING APPARATUS, CONTROL METHOD THEREFOR, AND STORAGE MEDIUM

(71) Applicant: CANON KABUSHIKI KAISHA, Tokyo (JP)

(72) Inventor: RYOSUKE NAKAISHI, Kanagawa (JP)

(21) Appl. No.: 19/549,198

(22) Filed: Feb. 25, 2026

(30) Foreign Application Priority Data
Mar. 4, 2025 (JP) 2025-034029

(51) Int. Cl. G06K 15/00; G06K 15/10; G06Q 30/0601

(52) U.S. Cl. CPC G06K 15/4075; G06K 15/002; G06K 15/102; G06Q 30/0643

(57) ABSTRACT

An information processing apparatus comprising: one or more memory devices that store a set of instructions; and one or more processors that execute the set of instructions to: accept, from a user, selection of a number of printed sheets to be permitted for printing in an image forming apparatus; and issue a first notification regarding delivery of a consumable of the image forming apparatus and a second notification regarding the number of printed sheets to be permitted for printing in a case where a remaining amount of a recording agent included in the consumable of the image forming apparatus is equal to or less than a first threshold and a number of printed sheets permitted for printing by the image forming apparatus is equal to or less than a second threshold.

### BACKGROUND

### Field of the Technology

The present disclosure relates to an information processing apparatus, a control method therefor, and a storage medium.

### Description of the Related Art

As in Japanese Patent Laid-Open No. 2022-129488, there is a known prepaid print service that can use a print function of an image forming apparatus such as a copying machine or an inkjet printer for the number of charged sheets purchased in advance by a user. Japanese Patent Laid-Open No. 2022-129488 describes that a notification of a shortage of a remaining ink amount is issued to the user in a case where the number of newly charged sheets is larger than the number of printable sheets estimated from the remaining ink amount.

It is conceivable that the prepaid print service displays a delivery application screen for new ink for the user in a case where the remaining ink amount is low. Therefore, even for a user who does not plan to use the prepaid print service in the future, the delivery application screen is displayed if the number of printable sheets acquired from the remaining ink amount is small (e.g., one sheet). In such a case, the user cancels the delivery application by operating the screen, which deteriorates the user experience. In a case where the user feels the cancellation operation troublesome and does not cancel, it is conceivable that the user does not execute printing although ink is delivered to the user. In such a case, it leads to an increase in unnecessary delivery cost and discard of ink, and the environmental burden increases.

### SUMMARY

The present disclosure enables realization of a technique that can suppress deterioration in user experience regarding a delivery application for a consumable of an image forming apparatus in a prepaid print service.

One aspect of the present disclosure provides an information processing apparatus comprising: one or more memory devices that store a set of instructions; and one or more processors that execute the set of instructions to: accept, from a user, selection of a number of printed sheets to be permitted for printing in an image forming apparatus; and issue a first notification regarding delivery of a consumable of the image forming apparatus and a second notification regarding the number of printed sheets to be permitted for printing in a case where a remaining amount of a recording agent included in the consumable of the image forming apparatus is equal to or less than a first threshold and a number of printed sheets permitted for printing by the image forming apparatus is equal to or less than a second threshold.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a schematic diagram of an information processing system according to one embodiment.

FIG. 2 is a hardware configuration diagram of a print service server according to one embodiment.

FIG. 3 is a hardware configuration diagram of a printer according to one embodiment.

FIG. 4 is a hardware configuration diagram of a client terminal according to one embodiment.

FIG. 5 is a view illustrating a display screen according to one embodiment.

FIG. 6 is a view illustrating a display screen according to one embodiment.

FIG. 7 is a flowchart of processing according to one embodiment.

FIG. 8 is a flowchart of processing according to one embodiment.

FIG. 9 is a view illustrating a display screen according to one embodiment.

FIG. 10 is a view illustrating a display screen according to one embodiment.

FIG. 11 is a flowchart of processing according to one embodiment.

FIG. 12 is a flowchart of processing according to one embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### Embodiment

### Configuration of Information Processing System

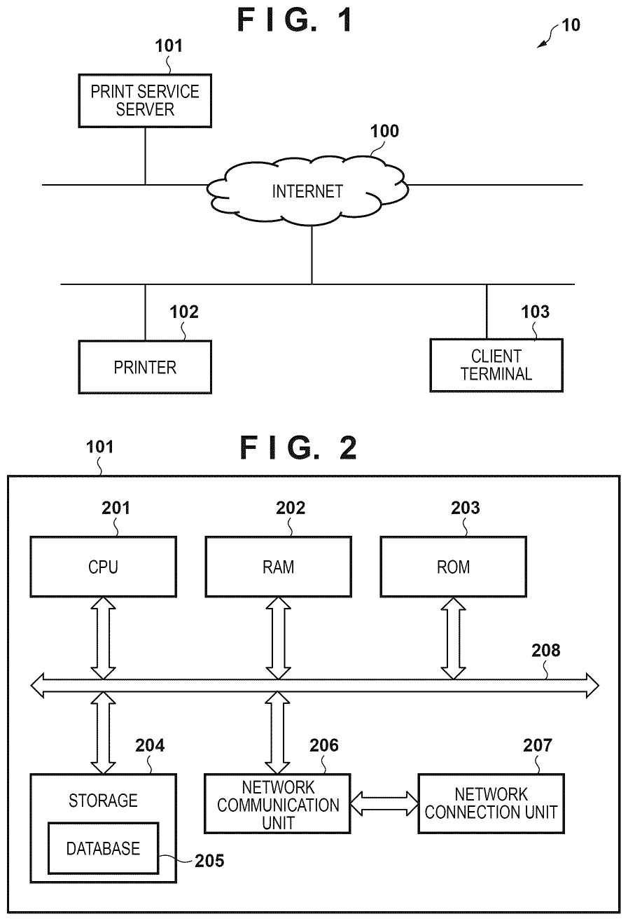

An outline of an information processing system 10 according to the present embodiment will be described with reference to FIG. 1. The information processing system 10 is configured to include a print service server 101, a printer 102, and a client terminal 103. The print service server 101, the printer 102, and the client terminal 103 are connected to each other via the Internet 100. The print service server 101 manages information transmitted from the printer 102 and information on a prepaid print service. The protocol of each communication is, for example, HTTP, but the protocol is not limited to this, and may be another protocol. The printer 102 is, for example, a multi-function peripheral, and transmits status information including information such as a remaining ink amount together with identification information (such as a serial number) of the printer 102 to the print service server 101 when an event such as printing occurs or periodically.

Note that in the present embodiment, the printer 102, which is a multi-function peripheral, is exemplified as an example of the image forming apparatus, but the image forming apparatus to which the present embodiment is applicable need not be a multi-function peripheral. That is, the printer 102 may be replaced with a copying machine, a facsimile machine, or the like. The printer 102 may be a printer that does not have a scanner function. In the present embodiment, the print method for the printer 102 is exemplified by an inkjet method for performing recording using ink, but may be a toner method using a recording material such as toner.

### Hardware Configuration of Print Service Server

A hardware configuration of the print service server 101 will be described with reference to FIG. 2. The print service server 101 is configured to include a CPU 201, a RAM 202, a ROM 203, a storage 204, a network communication unit 206, and a network connection unit 207.

The CPU 201 is a central processing unit for controlling each unit of the print service server 101. The RAM 202 is a memory that functions as a work area, for example, when the CPU 201 executes a program stored in the ROM 203 or the like. The ROM 203 is a read-only memory for storing a boot program necessary for system boot, for example. The storage 204 is an apparatus for storing a program to be executed by the CPU 201, a database 205, or various types of information, and is a nonvolatile storage such as a magnetic disk or a flash memory, for example.

The network connection unit 207 is, for example, a connector through which a cable for connecting the print service server 101 to the Internet 100 can be inserted and removed. The network communication unit 206 is configured to include a communication module, connects the print service server 101 to a network such as the Internet 100 via the network connection unit 207, and performs various types of communication. The above-described components are mutually connected by a bus 208, and can mutually transmit and receive data. Note that in FIG. 1, the number of print service server 101 is one, but may be a plurality of servers. That is, each function may be implemented by a plurality of servers operating in cooperation.

### Configuration Example of Information Managed by Print Service Server

The database 205 stored in the storage 204 of the print service server 101 holds an identifier of a printer such as a serial number as shown in Table 1 described later, and a remaining ink amount and remaining charge amount information of a printing sheet corresponding to the identifier of the printer. Note that the remaining charge amount is the number of printable sheets, for example.

TABLE 1
CORRESPONDENCE BETWEEN REMAINING INK AMOUNT
AND REMAINING CHARGE AMOUNT FOR EACH PRINTER

| | REMAINING | REMAINING |
|---|---|---|
| SERIAL NUMBER | INK AMOUNT | CHARGE AMOUNT |
| AAAA00000 | 10% | 1 |
| BBBB11111 | 20% | 100 |

### Hardware Configuration of Printer

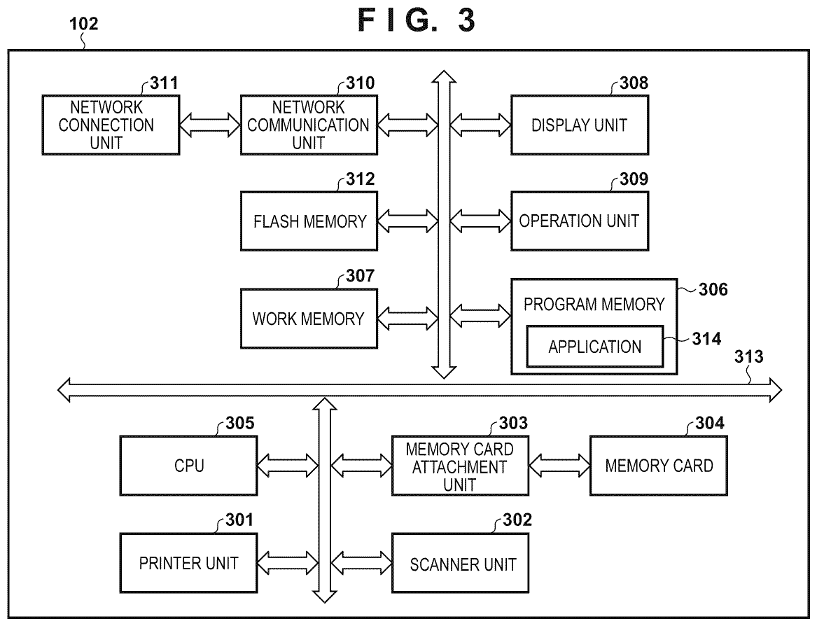

A hardware configuration of the printer 102 will be described with reference to FIG. 3. The printer 102 is configured to include a printer unit 301, a scanner unit 302, a memory card attachment unit 303, a memory card 304, a CPU 305, a program memory 306, and a work memory 307. The printer 102 is configured to include a display unit 308, an operation unit 309, a network communication unit 310, a network connection unit 311, and a flash memory 312.

The printer unit 301 executes print processing in the printer 102. More specifically, the printer unit 301 is configured to include a nozzle that discharges ink and a belt that conveys paper. Then, the printer unit 301 records (i.e., prints) an image on a recording medium such as a printing sheet by an inkjet method using image data received from the outside, image data in a state of being stored in the memory card 304, or the like. Furthermore, the printer unit 301 manages paper information including remaining ink amount information and information on the number of loaded pieces of paper.

The scanner unit 302 is configured to include an image capturing apparatus, and optically reads a document set on a document table to convert it into electronic data. Then, the scanner unit 302 converts the read image data into a designated file format and transmits it to an external apparatus via a network. The scanner unit 302 stores the converted image data in a storage area such as the flash memory 312.

Note that by such a printer unit 301 and scanner unit 302 cooperating with each other, copy processing can be executed. That is, the scanner unit 302 transmits, to the printer unit 301, the image data generated by reading the document placed on the document table. Then, the printer unit 301 can receive this image data to print the image on a recording medium.

The memory card attachment unit 303 is a connector having a structure in which the memory card 304 can be inserted and removed, for example. The memory card 304 attached to the memory card attachment unit 303 stores various types of file data. This file data can be read from an external apparatus via a network and edited. It is also possible to store file data in the memory card 304 in response to an instruction from an external apparatus.

The CPU 305 is a central processing unit for controlling each component in the printer 102. The program memory 306 is configured to include a ROM, and stores various program codes and an application 314 for communicating with the print service server 101. The work memory 307 is configured to include a RAM and the like. The work memory 307 temporarily stores image data and the like at the time of execution of each service. Buffering is performed using the work memory 307.

The display unit 308 is configured to include, for example, a liquid crystal display (LCD), and displays various types of information. The operation unit 309 is configured to include a switch and the like for the user to perform various input operations. Note that in a case of being configured to include, for example, a touch panel display, the display unit 308 also functions as the operation unit 309.

The network connection unit 311 is configured to include a communication cable, a wireless communication antenna and the like. The network communication unit 310 is configured to include a communication module, and connects the printer 102 to a network such as the Internet 100 via the network connection unit 311 to perform various types of communication. In various types of communication, control is performed through HTTP or the like. Note that the protocol is not limited to this, and other protocols may be used. The flash memory 312 is a nonvolatile memory for storing image data received by the network communication unit 310 and data regarding a prepaid print service. Note that the data regarding a prepaid print service is, for example, a remaining charge amount, an error history, system information on the printer 102, subscription service information, and the like. The above-described components are mutually connected by a bus 313, and can mutually transmit and receive data.

### Configuration of Client Terminal

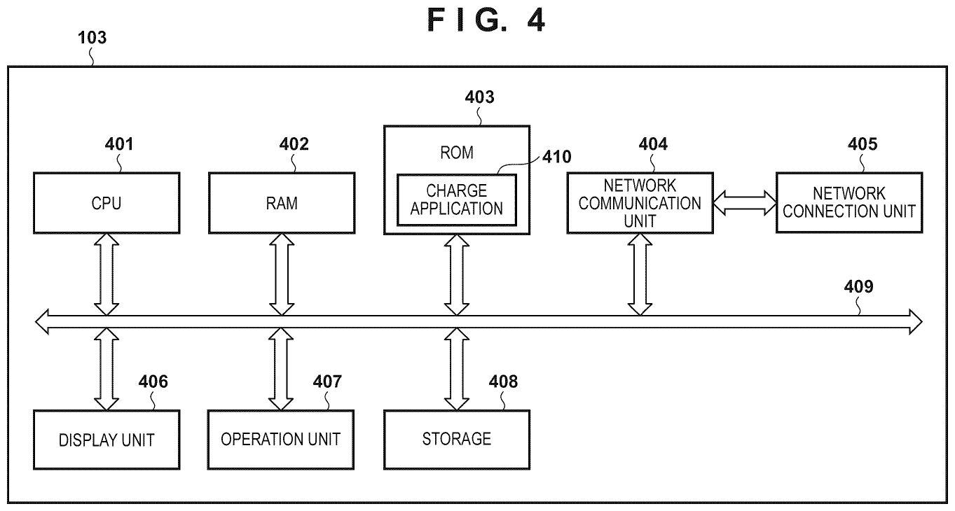

A hardware configuration of the client terminal 103 will be described with reference to FIG. 4. The client terminal 103 is configured to include a CPU 401, a RAM 402, a ROM 403, a network communication unit 404, a network connection unit 405, a display unit 406, an operation unit 407, and a storage 408.

The CPU 401 is a central processing unit for controlling each component of the client terminal 103. The RAM 402 is a memory that functions as a work area when the CPU 401 executes a program stored in the ROM 403 or the like. The ROM 403 stores an operating system, a charge application 410, and the like.

Note that the charge application 410 accepts an operation from the user. Then, it provides a function of transmitting a message including a character string input by the operation and an image file (image data) to an external apparatus via the Internet 100. Note that the transmission destination is, for example, the print service server 101. The charge application 410 notifies the user of the message received via the print service server 101. The charge application 410 also provides a function of opening a web page inside the application. Note that the screen provided by the charge application 410 is not limited to being displayed by a dedicated application, and may be displayed by a web browser, a remote UI, or the like. These applications are read and executed by the CPU 401.

The network connection unit 405 is configured to include a communication cable and a wireless communication antenna. The network communication unit 404 is configured to include a communication module, and connects the client terminal 103 to the Internet 100 via the network connection unit 405. That is, the network communication unit 404 is connected to a network such as the Internet 100 via the network connection unit 405, and performs various types of communication. The network communication unit 404 can support, for example, a wireless LAN.

The display unit 406 is configured to include, for example, an LCD, and displays various types of information. The operation unit 407 is configured to include buttons and a keyboard, and performs control of information operated by the user. Note that in a case of being configured to include, for example, a touch panel display, the display unit 406 also functions as the operation unit 407. The storage 408 is a nonvolatile storage apparatus, and stores various operation mode settings, operation logs, and the like that need to be held even after the client terminal 103 is restarted. The above-described components are mutually connected by a bus 409, and can mutually transmit and receive data. Note that the client terminal 103 may be, for example, a smartphone, a personal computer, a tablet terminal, or the like.

### Processing of Controlling Transmission Of Delivery Application Screen According to State of Printer

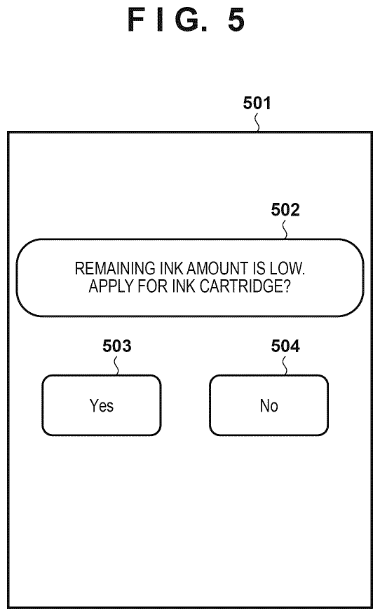

Processing in which a delivery application screen 501 is displayed when the number of printable sheets of the prepaid print service is charged using the charge application 410 of the client terminal 103 will be described with reference to FIGS. 5 to 8. Note that display control of the delivery application screen 501 is performed according to the state of the printer 102, that is, the remaining ink amount and the remaining charge amount of the printer 102.

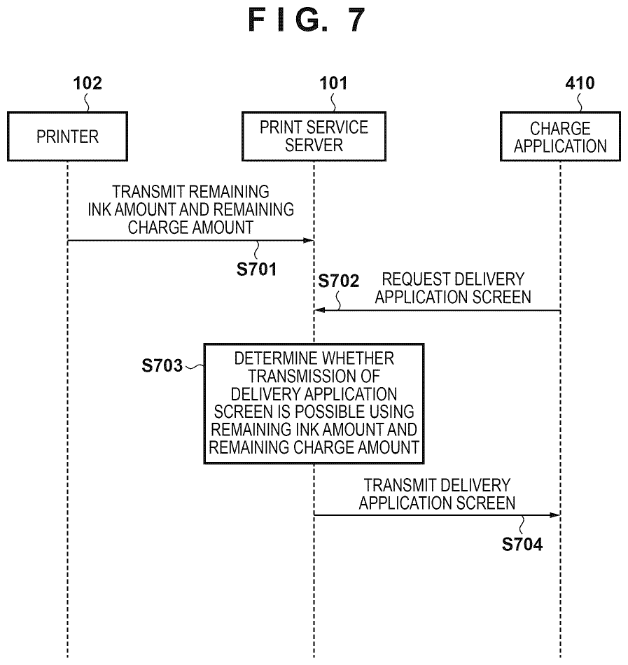

Sequence processing in which the charge application 410 acquires the delivery application screen 501 will be described with reference to FIG. 7. Note that this processing is implemented by the respective CPUs provided in the print service server 101, the printer 102, and the client terminal 103 reading and executing a program stored in the respective storage media. Communication among the print service server 101, the printer 102, and the client terminal 103 is executed using the network communication units provided respectively in them.

In S701, the CPU 305 of the printer 102 transmits the remaining ink amount and the remaining charge amount to the print service server 101 at an arbitrary timing such as power-on or end of printing, or periodically. Then, the CPU 201 (an example of “acquisition unit”) of the print service server 101 receives the remaining ink amount and the remaining charge amount. Then, the CPU 201 stores, in the RAM 202 or the like, the remaining ink amount and the remaining charge amount in association with the serial number of the printer 102 as shown in Table 1. Note that the remaining ink amount is an example of “usage of consumable of a consumable component used for printing in the image forming apparatus”. The remaining charge amount is an example of “number of printable sheets”.

In S702, the charge application 410 in a state of being executed by the CPU 401 in the client terminal 103 makes a request for the delivery application screen 501 to the print service server 101. Then, the CPU 201 of the print service server 101 receives this request.

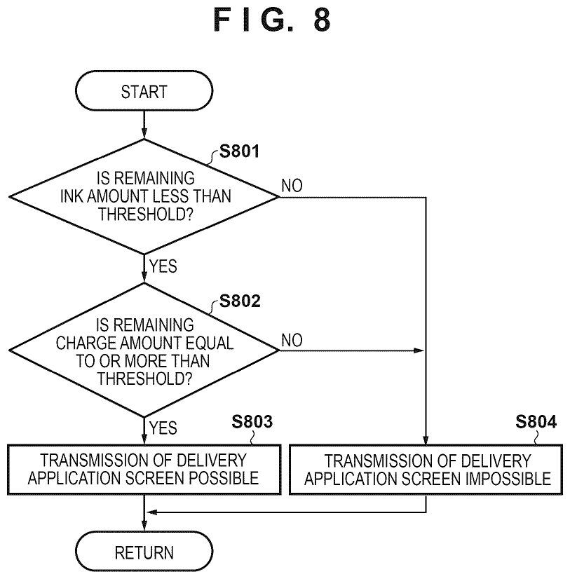

In S703, the CPU 201 of the print service server 101 determines whether or not to transmit the delivery application screen to the charge application 410. FIG. 8 exemplifies details of this determination processing. Note that the processing of FIG. 8 is implemented by the CPU 201 of the print service server 101 reading and executing a program stored in the ROM 203 or the like.

In S801, the CPU 201 of the print service server 101 refers to a printer information table (Table 1) in a state of being stored in the database 205. Then, the CPU 201 (an example of “first determination unit”) determines whether or not the remaining ink amount is less than a predetermined threshold. Then, in a case where the CPU 201 determines that it is less than the threshold, the processing proceeds to S802, and otherwise, the processing proceeds to S804.

In S802, the CPU 201 (an example of “second determination unit”) determines whether or not the remaining charge amount is equal to or more than a predetermined threshold. Then, in a case where the CPU 201 determines that it is equal to or more than the threshold, the processing proceeds to S803, and otherwise, the processing proceeds to S804.

In S803, the CPU 201 determines that transmission of the delivery application screen is possible. Then, the processing proceeds to S704 of FIG. 7. On the other hand, in S804, the CPU 201 determines that transmission of the delivery application screen is impossible. Then, the processing ends.

The description returns to the sequence flow of FIG. 7. In S704, in a case of determining in S703 that the transmission of the delivery application screen is possible, the CPU 201 (an example of “generation unit”) of the print service server 101 generates the delivery application screen 501. Then, the CPU 201 transmits the delivery application screen 501 to the charge application 410 in response to the request for the delivery application screen in S702. Then, the charge application 410 acquires and displays this delivery application screen 501. On the other hand, in a case where it is determined in S703 that the transmission of the delivery application screen is impossible, the transmission of the delivery application screen 501 is not executed. Then, the processing ends.

FIG. 5 exemplifies such a delivery application screen 501. The delivery application screen 501 includes a message 502 inquiring whether to apply for delivery of an ink cartridge, a button 503 for executing the delivery application, and a button 504 for canceling the delivery application. When the user selects and operates such a button 503, the CPU 401 of the client terminal 103 accepts this operation using the operation unit 407. Note that the button 503 is an example of “first object indicative of being operable”. Then, the CPU 401 transmits this delivery application to a predetermined server, thereby starting a delivery procedure for the user.

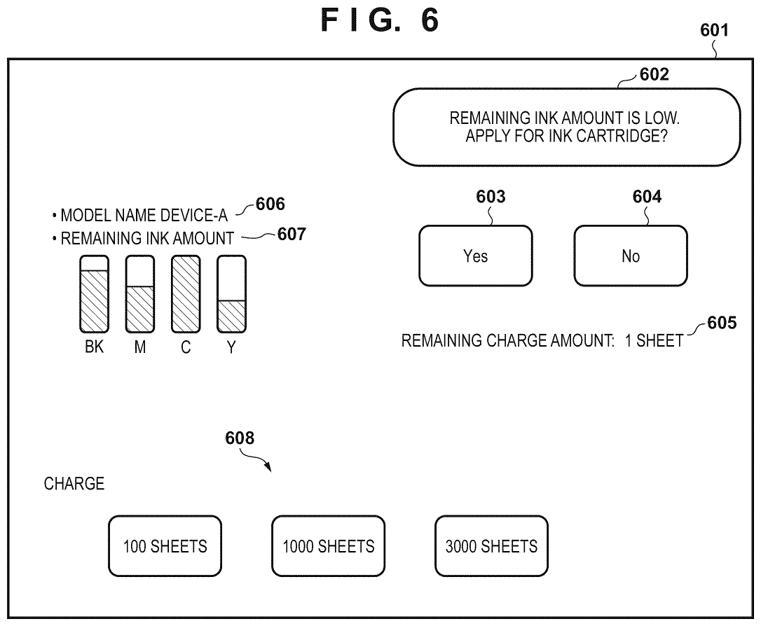

FIG. 6 illustrates another example of delivery application screen. Similarly to FIG. 5, a delivery application screen 601 illustrated in FIG. 6 includes a message 602 inquiring whether to apply for delivery of an ink cartridge, a button 603 for executing the delivery application, and a button 604 for canceling the delivery application. In addition, the delivery application screen 601 includes information 605 indicating the remaining charge amount, information 606 indicating the model name of the printer, information 607 indicating the remaining ink amount, and a button 608 for selecting a new number of charges. Note that the information 607 and the button 608 are examples of “fourth object”.

Such delivery application screens (501 and 601) are screens that are first displayed when the user starts the charge application. The user can confirm the status of the printer, such as addition of a charge or remaining amount confirmation, or the remaining ink amount.

### One Aspect of Actions and Effects

According to the present embodiment, when the user charges the number of printable sheets of the prepaid print service using the charge application 410, the following control becomes possible. That is, the print service server 101 can control transmission of the delivery application screen to the charge application 410 according to the remaining ink amount and the remaining charge amount of the printer 102. This can prevent an unnecessary delivery application screen for the user from being displayed. Hence, deterioration of the user experience can be suppressed. It is possible to prevent the user from feeling the cancel operation troublesome. Hence, it is possible to prevent ink from being delivered without the user canceling it. Hence, it leads to prevention of an increase in unnecessary delivery cost and prevention of discard of delivered ink, and an increase in environmental load can be suppressed.

### First Modification

In the above embodiment, it is determined that transmission of the delivery application screen is possible in a case where the predetermined condition is satisfied in the flowchart shown in FIG. 8. On the other hand, in a first modification, in a case where the predetermined condition is not satisfied, the delivery application screen displays a message prompting charging of a shortage, and displays a button for executing the delivery application in an inoperable manner. Note that here, description of similar content to that of the embodiment will be omitted as appropriate, and differences from the embodiment will be mainly described.

### Processing of Displaying Additional Message on Delivery Application Screen According to State of Printer

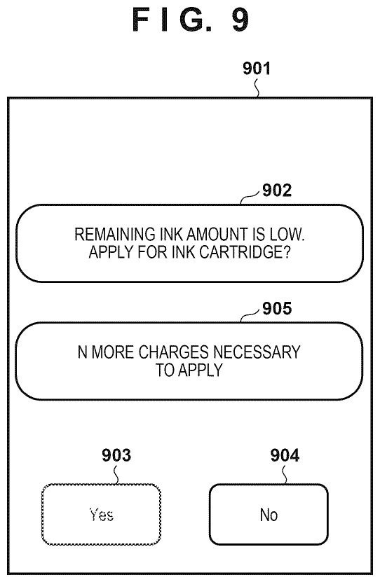

FIG. 9 exemplifies a delivery application screen according to the first modification. Similarly to the embodiment, a delivery application screen 901 includes a message 902 inquiring whether to apply for an ink cartridge, a button 903 for executing the delivery application, and a button 904 for canceling the delivery application. Note that the button 903 is an example of “second object for applying for delivery indicative of being inoperable”. In addition, the delivery application screen 901 includes a message 905 indicating the number of charges necessary for delivery. At this time, since the remaining ink amount and the remaining charge amount are less than the thresholds, the button 903 is displayed in a grayed out state (details will be described later). Note that the grayed out state is an example of “distinguishably display”. The charge application 410 does not accept an operation on such a button 903. Alternatively, the delivery application screen 901 may display, as a substitute for the button 903, a URL (an example of “third object”) to a charge purchase screen or the like.

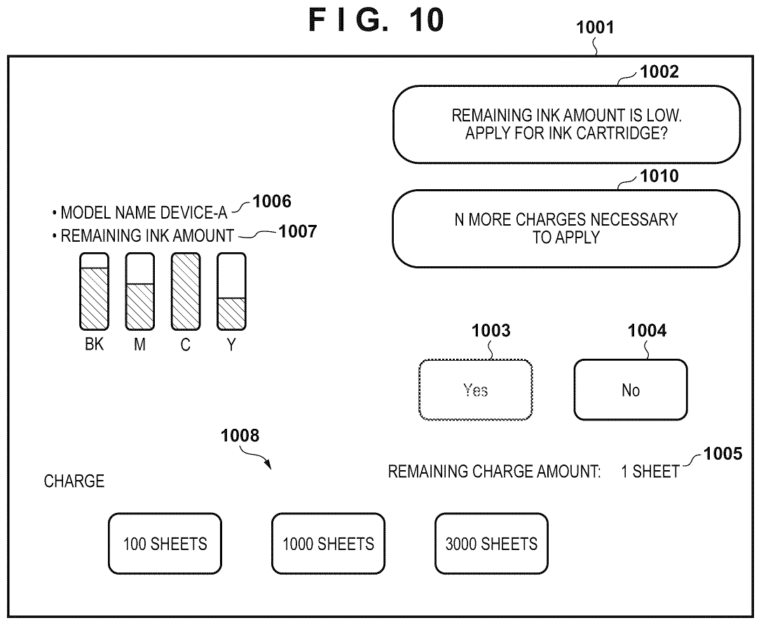

FIG. 10 illustrates another example of the delivery application screen according to the first modification. Similarly to FIG. 9, a delivery application screen 1001 illustrated in FIG. 10 includes a message 1002 inquiring whether to apply for delivery of an ink cartridge, a button 1003 for executing the delivery application, and a button 1004 for canceling the delivery application. The delivery application screen 1001 includes a message 1010 indicating the number of charges necessary for delivery. In addition, the delivery application screen 1001 includes information 1005 indicating the remaining charge amount, information 1006 indicating the model name of the printer, information 1007 indicating the remaining ink amount, and a button 1008 for selecting a new number of charges. The button 1003 is displayed in a grayed out state, similarly to FIG. 9.

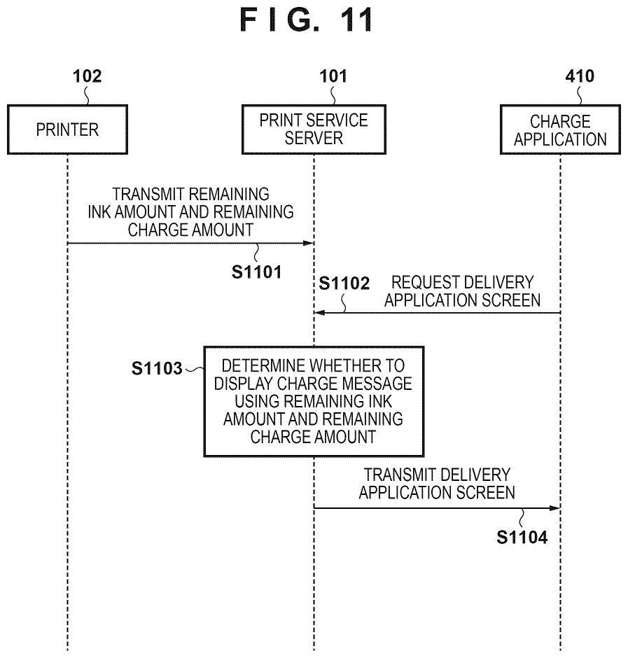

Sequence processing in which the charge application 410 acquires the delivery application screen will be described with reference to FIG. 11. Note that this processing is implemented by the respective CPUs provided in the print service server 101, the printer 102, and the client terminal 103 reading and executing a program stored in the respective storage media. Communication among the print service server 101, the printer 102, and the client terminal 103 is executed using the network communication units provided respectively in them.

In S1101, the CPU 305 of the printer 102 transmits the remaining ink amount and the remaining charge amount to the print service server 101 at an arbitrary timing such as power-on or end of printing, or periodically. Then, the CPU 201 of the print service server 101 receives the remaining ink amount and the remaining charge amount. Then, the CPU 201 stores, in the RAM 202 or the like, the remaining ink amount and the remaining charge amount in association with the serial number of the printer 102 as shown in Table 1.

In S1102, the charge application 410 in a state of being executed by the CPU 401 in the client terminal 103 makes a request for a delivery application screen to the print service server 101. Then, the CPU 201 of the print service server 101 receives this request.

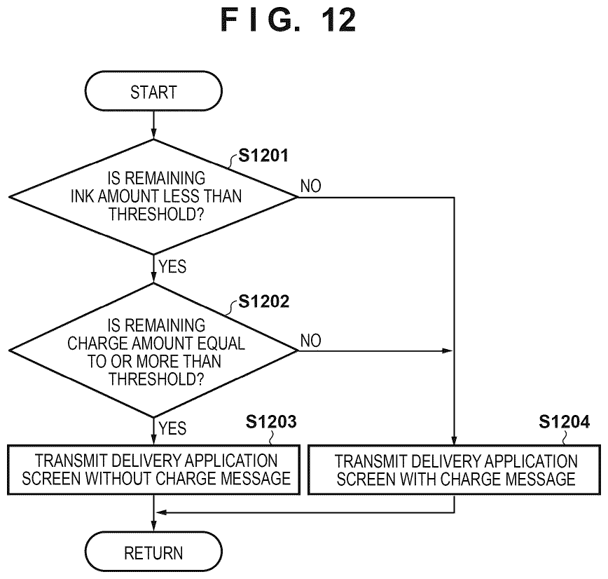

In S1103, the CPU 201 of the print service server 101 determines whether or not to display, on the delivery application screen, the message 905 indicating the number of charges necessary for delivery. FIG. 12 exemplifies details of this determination processing. Note that the processing of FIG. 12 is implemented by the CPU 201 of the print service server 101 reading and executing a program stored in the ROM 203 or the like.

In S1201, the CPU 201 of the print service server 101 refers to a printer information table (Table 1) in a state of being stored in the database 205. Then, the CPU 201 determines whether or not the remaining ink amount is less than a predetermined threshold. Then, in a case where the CPU 201 determines that it is less than the threshold, the processing proceeds to S1202, and otherwise, the processing proceeds to S1204. In S1202, the CPU 201 determines whether or not the remaining charge amount is equal to or more than a predetermined threshold. Then, in a case where the CPU 201 determines that it is equal to or more than the threshold, the processing proceeds to S1203, and otherwise, the processing proceeds to S1204.

In S1203, the CPU 201 determines not to display, on the delivery application screen, the message 905 indicating the number of charges necessary for delivery. Then, the processing proceeds to S1104. On the other hand, in S1204, the CPU 201 determines to display, on the delivery application screen, the message 905 indicating the number of charges necessary for delivery. Then, the processing proceeds to S1104 of FIG. 11.

In S1104, the CPU 201 of the print service server 101 generates a delivery application screen. At this time, in a case of determining to display, on the delivery application screen, the message 905 indicating the number of charges necessary for delivery in S1204, the CPU 201 generates the delivery application screen (FIG. 9 or FIG. 10) including the message 905. At this time, the CPU 201 grays out the button 503 for executing the delivery application. Note that the CPU 201 does not accept an operation input to the button 503 displayed in a grayed out manner.

On the other hand, in a case of determining not to display the message 905 in S1203, the CPU 201 generates a delivery application screen not including the message 905. The delivery application screen not including the message 905 is, for example, the screen illustrated in FIG. 5 or 6 according to the embodiment. Then, the CPU 201 transmits the generated delivery application screen to the charge application 410 in response to the request for the delivery application screen in S1102. Then, the charge application 410 acquires and displays this delivery application screen. Then, the processing ends.

### One Aspect of Actions and Effects

According to the first modification, similar effects to those of the above embodiment can be obtained. According to the first modification, the user can confirm that the delivery application cannot be made in a case where the user does not charge on the delivery application screen. Hence, convenience of the user can be enhanced.

### Other Modifications

In the above, ink is exemplified as an example of the consumable component used for printing by the printer 102, but the consumable component is not limited to ink. For example, the consumable component may be genuine print paper of a manufacturer of the printer 102. Then, the embodiment or the first modification may be applied to the delivery application of the print paper in place of the ink.

In a case where the printer 102 is an image forming apparatus of a toner method, the consumable component may be a toner cartridge, a photosensitive drum, or the like. Then, the embodiment or the first modification described above may be applied to a delivery application of a consumable component of the image forming apparatus of the toner method such as a toner cartridge or a photosensitive drum in place of ink.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-034029, filed Mar. 4, 2025, which is hereby incorporated by reference herein in its entirety.

What is claimed is:

1. An information processing apparatus comprising:
one or more memory devices that store a set of instructions; and
one or more processors that execute the set of instructions to:
accept, from a user, selection of a number of printed sheets to be permitted for printing in an image forming apparatus; and
issue a first notification regarding delivery of a consumable of the image forming apparatus and a second notification regarding the number of printed sheets to be permitted for printing in a case where a remaining amount of a recording agent included in the consumable of the image forming apparatus is equal to or less than a first threshold and a number of printed sheets permitted for printing by the image forming apparatus is equal to or less than a second threshold.

2. The information processing apparatus according to claim 1, wherein
display of a screen including the first notification and the second notification is performed in a case where the remaining amount of the recording agent included in the consumable of the image forming apparatus is equal to or less than the first threshold and the number of printed sheets permitted for printing by the image forming apparatus is equal to or less than the second threshold.

3. The information processing apparatus according to claim 2, wherein
the screen displays a second object for applying for the delivery in an inoperable state.

4. The information processing apparatus according to claim 3, wherein
the one or more processors execute instructions in the one or more memory devices to:
generate the screen distinguishably displaying that the second object is inoperable.

5. The information processing apparatus according to claim 2, wherein
the screen includes information on the number of printed sheets to be permitted for printing by the image forming apparatus necessary for applying for the delivery.

6. The information processing apparatus according to claim 2, wherein
the screen includes a third object indicating a URL of a screen for purchasing the number of printed sheets to be permitted for printing by the image forming apparatus, and wherein
the one or more processors execute instructions in the one or more memory devices to:
generate the screen including the third object in a case where the number of printed sheets permitted for printing by the image forming apparatus is equal to or less than the second threshold.

7. The information processing apparatus according to claim 2, wherein
the screen further includes remaining amount information of the consumable and a fourth object for accepting, from the user, selection of the number of printed sheets to be permitted for printing in the image forming apparatus.

8. The information processing apparatus according to claim 1, wherein
a print method for the image forming apparatus includes an inkjet method, and
a usage of consumable includes a remaining amount of ink to be used for printing in the image forming apparatus.

9. A control method for an information processing apparatus, the control method comprising:
accepting, from a user, selection of a number of printed sheets to be permitted for printing in an image forming apparatus; and
issuing a first notification regarding delivery of a consumable of the image forming apparatus and a second notification regarding the number of printed sheets to be permitted for printing in a case where a remaining amount of a recording agent included in the consumable of the image forming apparatus is equal to or less than a first threshold and a number of printed sheets permitted for printing by the image forming apparatus is equal to or less than a second threshold.

10. A non-transitory computer-readable storage medium storing a computer program for causing a computer to execute each step in a control method for an information processing apparatus, the control method comprising:
accepting, from a user, selection of a number of printed sheets to be permitted for printing in an image forming apparatus; and
issuing a first notification regarding delivery of a consumable of the image forming apparatus and a second notification regarding the number of printed sheets to be permitted for printing in a case where a remaining amount of a recording agent included in the consumable of the image forming apparatus is equal to or less than a first threshold and a number of printed sheets permitted for printing by the image forming apparatus is equal to or less than a second threshold.
